(19) United States
(12) Patent Application Publication
(10) Pub. No.: US 2010/0231059 A1
(43) Pub. Date: Sep. 16, 2010

(54) LAMINATED CORE OF AN ELECTRIC LINEAR MOTOR

(75) Inventor: Gerhard Matscheko, Starnberg (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: SIEMENS AKTIENGESELLSCHAFT, Muenchen (DE)

(21) Appl. No.: 12/293,950

(22) PCT Filed: Feb. 12, 2007
(86) PCT No.: PCT/EP2007/051332

§ 371 Date: Sep. 22, 2008

(30) Foreign Application Priority Data
Mar. 21, 2006 (DE) 10 2006 013 259.9

(51) Int. Cl. H02K 41/03

(52) U.S. Cl. 310/12.24

(57) ABSTRACT

The invention relates to a laminate stack (7) of an electric linear motor (1) or a primary part (3) and/or a secondary part (5), which has a corresponding laminate stack. The laminate stack (7) has a means (10) for forming a frictional and/or interlocking connection between individual laminates (15) of the laminate stack (7), wherein the means (10) has holding elements (20) and/or is in the form of a clasp, wherein the means (10) in the form of a clasp has in particular holding elements (20), wherein the means is designed to have one or more parts.

The invention relates to a laminated core of a primary part or to the laminated core of a secondary part of an electric linear motor. The electric linear motor, which in particular is in the form of a synchronous machine with permanent-magnet excitation, has the primary part and the secondary part. The electric linear motor can advantageously also be used in a generator operating mode. By way of example, the linear motor can be designed such that the primary part has windings through which current can flow, and the secondary part has permanent magnets.

If an electric linear motor, such as a synchronous linear motor, has a means for guiding the magnetic flux, then this means can in particular be designed in a laminated form, for higher pole changing frequencies. The laminated form makes it possible to reduce eddy currents.

Since the production of a laminated core is physically complex, the object of this invention is to specify a laminated core whose design and production are simplified.

In the case of apparatuses, this object is achieved by the respective features of claims 1, 10 and 13. Dependent claims 2 to 9, 11 and 12 are advantageous developments of the claimed apparatuses.

A laminated core of an electric linear motor has laminates. The laminated core also has a means for forming a friction and/or interlocking connection between individual laminates, with the means in particular being a clip and/or having a holding bracket. In particular, the means is formed from one or more parts. The means, which therefore for example has holding elements and/or is in the form of a clip, with the means which is in the form of a clip in particular having holding elements, is used to hold the laminates of the laminated core together. The use of a friction and/or interlocking connection makes it possible to design the laminated core such that it is free of at least one or else of more of the following connection types in order to arrange the laminates in a row to form the laminated core: screw connection, integral material connection (for example welded joint) or adhesively bonded connection.

In one advantageous refinement of the electric linear motor, this electric linear motor has:
a primary part which has windings through which current can flow, and permanent magnets, and
a secondary part, which is free of permanent magnets, with the secondary part having a means for guiding a magnetic flux, and with this means having a laminated core.

In a conventional linear motor, the secondary part has permanent magnets. The laminated core has individual laminates arranged in a row. These laminates may also be referred to as sheet-metal laminates. Since friction and/or interlocking connections are used to form the laminated core, the laminated core can be produced particularly easily, quickly and at low cost. The means which is used to form the friction and/or interlocking connection is advantageously also intended to be fitted to a supporting part. By way of example, the supporting part is a machine bed or else a mounting plate. By way of example, the mounting plate is fitted or can be fitted to a machine bed or else to a foundation. This fitting process is carried out, for example, by means of a screw connection, a riveted connection, a welded joint, etc.

Since the means for forming the friction and/or interlocking connection may be formed from one or more parts, it is also possible, for example, for the supporting part to be a part of this means.

In one advantageous refinement of the laminated core, the means which is in the form of a clip has holding elements, with the means which is in the form of a clip having at least two holding elements on one end face of the laminated core. The end face relates to a transverse end face, that is to say to a face which runs parallel to an axial longitudinal direction of the linear motor, with the transverse end face running transversely with respect to an axial end face. The axial longitudinal direction indicates the direction of the linear movement which can be carried out by the linear motor. The laminated core has end laminates on the transverse end faces. By way of example, the holding element is a holding pin, a holding bracket or else a holding hook. The individual laminates are clamped in between a first holding element on a first transverse end face and a second holding element on a second transverse end face, in order to form a laminated core.

The laminated core is advantageously developed such that the means which is in the form of a clip and the laminates have a type of tongue-and-groove connection. If the means which is in the form of a clip has a groove, then the laminates have a tongue. If the means which is in the form of a clip has a tongue, then the laminates have a groove. The tongue-and-groove connection is one example of a connection by means of a positive shape and a negative shape, representing an interlocking connection. This shape allows the laminates to be positioned more easily with respect to the means for forming the friction and/or interlocking connection. Furthermore, this shape improves the force transmission.

The laminated core advantageously has end laminates on the transverse end faces which are stiffer than the laminates between the end laminates on the two transverse end faces. The stiffer form serves to distribute force better, with the force emanating from the means in order to form a friction and/or interlocking connection.

In a further advantageous refinement of the laminated core, the means which is in the form of a clip, that is to say in particular a clip, is fixed on a supporting body. The supporting body is the supporting part which, for example, is a flat plate or else the bed of a machine tool, or else the bed of a production machine. A secondary part can be lengthened very easily by arranging supporting parts linearly in a row.

The means which is in the form of a clip and/or the holding element are/is in particular designed such that they or it has a geometric shape in order to form a spring force. By way of example, a curved shape or else a hooked shape may be used for this purpose. A leaf-spring geometry is also possible.

The laminates in the laminated core in a further advantageous refinement of the laminated core have embossed areas. As the embossing, an embossed laminate has at least one depressed area and one raised area. The raised area in this case presupposes the depressed area, and vice versa. Individual laminates are in this case arranged in a row such that the raised area on a first laminate engages in the depressed area in a second laminate. This makes it easier to position the laminates and makes the laminated core more robust, in particular during assembly.

The laminated core is advantageously also used to form a secondary part, and/or is formed by this itself, with the secondary part in particular being free of sources to form a magnetic field. Sources such as these are, for example, permanent magnets or else coils through which an electric current flows. The laminated core can also be used for forming a primary part.

In the embodiments described above, laminated cores can therefore be used for a secondary part or else for a primary part of an electric linear motor. The laminated core then, as already described above, has a means for forming a friction and/or interlocking connection between individual laminates, with the means having holding elements and/or in particular being in the form of a clip, with the means which is in the form of a clip in particular having holding elements, and with the means being formed from one or more parts.

If the primary part of an electric linear motor which in particular has permanent-magnet excitation has a laminated core according to the invention, then, as in the case of the secondary part, this makes it possible to reduce the production times. Since the laminated core has a means for forming a friction and/or interlocking connection between individual laminates, with the means having holding elements and/or in particular being in the form of a clip, with the means which is in the form of a clip in particular having holding elements and with the means being formed from one or more parts, this makes it possible to reduce the number of production steps since there is no longer any need for a screw connection or else a welded joint between the individual laminates of the laminated core.

The individual features of the invention can be combined with one another such that further apparatuses according to the invention result from a partial combination of different exemplary embodiments, some of which are also described in the following text.

The invention as well as further advantageous refinements of the invention, also as claimed in the features of the dependent claims, will be explained in more detail in the following text with reference to exemplary embodiments which are schematically illustrated in the drawing, without this restricting the invention to these exemplary embodiments. In the figures:

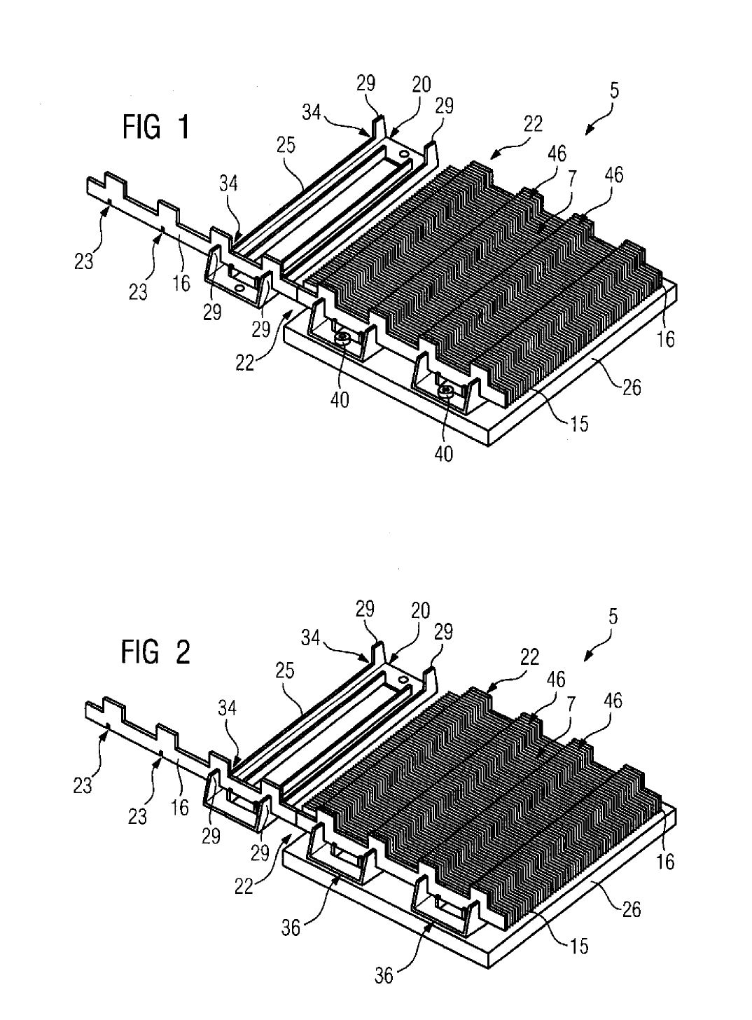

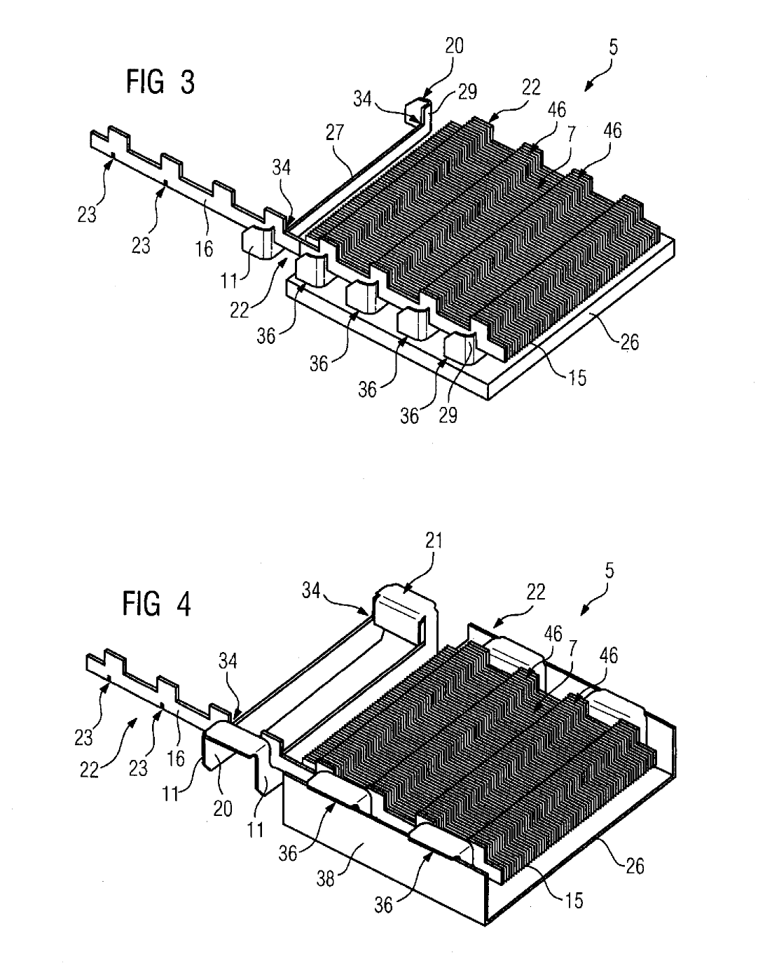

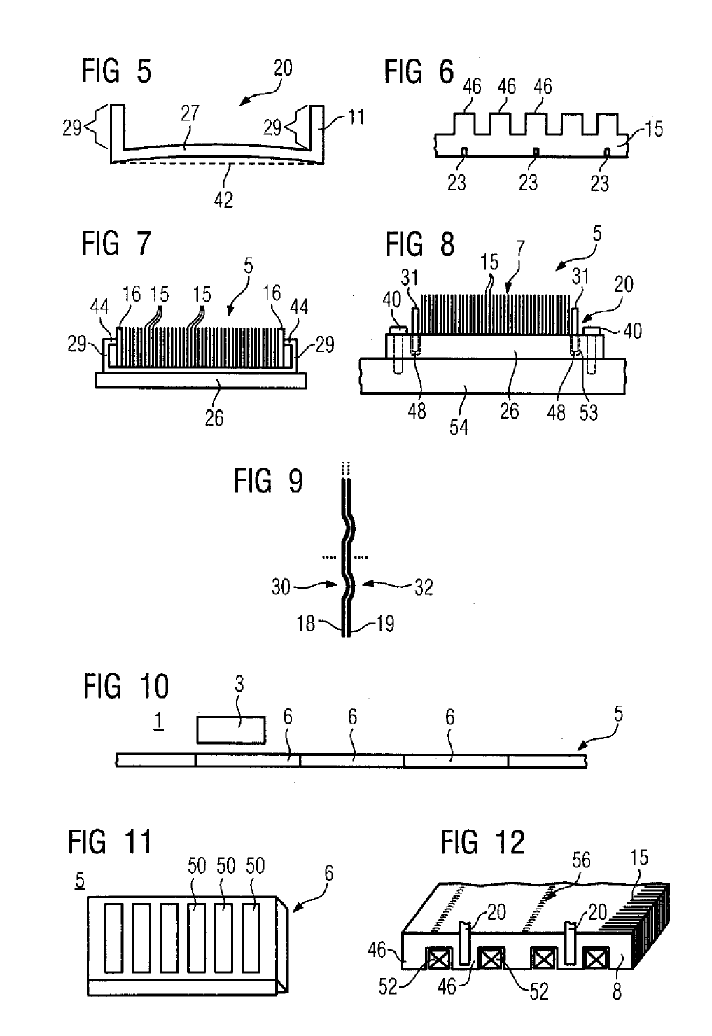

FIG. 1 shows a laminated secondary part with screwed-on holding elements,

FIG. 2 shows a laminated secondary part with welded-on holding elements,

FIG. 3 shows a laminated secondary part with welded-on means in the form of a clip,

FIG. 4 shows a laminated secondary part with holding elements with a U-profile,

FIG. 5 shows a curved holding element,

FIG. 6 shows a cross section through a laminate,

FIG. 7 shows a cross section through a secondary part,

FIG. 8 shows a second cross section through a secondary part,

FIG. 9 shows a cross section through embossed laminates,

FIG. 10 shows the basic design of a linear motor,

FIG. 11 shows a perspective view of a secondary part of a linear motor, and

FIG. 12 shows a cross section through a primary part of a linear motor.

The illustration in FIG. 1 shows a laminated secondary part 5, in the form of a perspective illustration. The secondary part 5 has a laminated core 7 which itself has teeth 42. The laminated core 7 is assembled from individual laminates 15, with end laminates 16 being provided, as shown in FIG. 1, on the end faces 27 along the movement direction of a linear motor with a secondary part 5. The laminates 15, together with the end laminates 16, are held by a holding element 20. The holding elements 20 are fixed on a supporting body 26 by means of screws 40. The holding element 20 in each case has two holding arms 29 on each of the end faces 22. The holding element 20 can also be designed such that, for example, it has only one holding arm or else three or two additional holding arms on each end face 22, although this is not illustrated in FIG. 1. The holding element 20 has a type of tongue 25. A laminate 15 can advantageously be placed on this tongue 25, with this laminate 15 having a groove 23 in the area of the tongue. In one advantageous refinement of the holding element 20, this holding element 20 has a cutout 34 in the area of the positioning of the end laminates 16, in which case the cutout 34 makes it possible to position the end laminates 16 better.

In a similar manner to FIG. 1, the illustration in FIG. 2 shows a laminated secondary part 5 with holding elements 20 in the form of holding brackets. However, as shown in FIG. 2, the holding elements 20 are not screwed on but are connected to the supporting body 26 by means of a welded joint. In particular, the supporting body 26 is a flat surface such as a machine bed. The illustrations shown in FIG. 1 and FIG. 2 show a laminated form of a secondary part of a linear motor, with this secondary part not having any permanent magnets. The secondary part is therefore free of all means for magnetic excitation.

The laminates in the laminated core of the secondary part are, for example, stamped, with the stamped laminates having slots, that is to say grooves, matching the pattern of the pole pitch on their rear face. The rear face is that face which is opposite the teeth 46 of the laminated core 7. The slots are advantageously used to hold holding brackets or holding webs, which are located transversely with respect to the layers of the laminates and are used as a holding element 20. The holding elements 20 have cutouts 34 on their side facing the face of the laminated core, in order to fix the laminates and end laminates at the side. In a further advantageous refinement, the laminates 15 in the laminated core 7 are welded on their rear face, that is to say on the side which is opposite the teeth 46.

Since the holding elements can be produced from stamped and bent parts in the form of holding brackets or holding webs, they can easily be matched both to the type of attachment and to the machine geometry, or else to an installation geometry. The secondary part 5 can also be welded to a machine body 26 and/or adhesively bonded there, or else can be screwed on, in which case the machine body or the supporting body may be flat or else, for example, formed in a U-shape, with a U-shape embodiment of the supporting body 26 being illustrated in FIG. 4.

The laminated core of the secondary part can be manufactured easily and at low cost because all of the laminates in the laminated core of the secondary part have the same laminate section. This also relates, of course, to laminated cores for a primary part. One particular advantage is that this design which is simple to manufacture also at the same time allows matching to a track width of a linear motor and to a specific installation situation for the linear motor, by means of the different form on the holding elements 20.

The illustration shown in FIG. 3 shows, as a holding element 20, a means 11 which is in the form of a clip and is welded onto the supporting body 26. On the end faces 22, the holding element 20 has holding arms 29 which, together with a connecting piece 27, form a clip. This represents a further embodiment of the invention.

The illustration in FIG. 4 shows, as the holding element 20, two means 11 which are in the form of clips and are connected to one another via a holding bracket 21. The holding bracket 21 allows the laminated core 7, which is held together by the holding elements 20, to be easily firmly welded on a U-profile 26, acting as a supporting body. The illustration in FIG. 4 indicates the welded joints 36 which are required for this purpose. Welded joints such as these for attachment of the holding elements 20 are also shown in FIGS. 2 and 3.

The laminated core 7 of the secondary part 5 is used to guide a magnetic flux, with the magnetic flux being guided corresponding to the teeth 46 that are formed, and with the teeth adjacent to the air gap to the primary part. A primary part which is designed for this secondary part but is not illustrated in FIGS. 1 to 4 has windings and permanent magnets. A linear motor such as this can be operated as a synchronous linear motor with permanent-magnet excitation.

The illustration in FIG. 5 shows a holding element 20. The holding element 20 is in the form of a means 11 in the form of a clip, with two holding arms 29 being connected to one another by means of a connecting piece 27. The connecting piece 27 is curved in such a way that the curvature can be counteracted by the positioning of laminates, which are not illustrated, between the holding arms 29, thus resulting in a holding stress for the laminates. The curvature can be seen from the straight line 42 that is illustrated by a dashed line.

The illustration in FIG. 6 shows the laminate section of a laminate 15. The laminate 15 has teeth 46 which are adjacent to an air gap. The primary part, which is not illustrated, is positioned opposite the teeth within the linear motor or the electrical machine. The laminate section furthermore has the grooves 23, with the grooves 23 being used to hold tongues which are formed by the holding elements that are not illustrated.

The illustration in FIG. 7 shows a cross section through the secondary part 5, which is directed transversely with respect to a movement direction of a linear motor. The holding element 20 has holding arms 29, with the holding arms 29 having tabs 44. The tabs 44 make contact with the end laminates 16 and press the laminates 15, 16, which are arranged in a row, together.

The illustration in FIG. 8 shows, in the form of a cross section, a further example of a secondary part 5, with the holding element 20 in FIG. 8 being implemented by means of a combination of holding supports 31 and a supporting body 26. The supporting body 26 has threaded holes 53, for example, into which holding supports 31 which have an external thread can be screwed. The laminates 15 are positioned as a laminated core 7 between the holding supports 31. The supporting body 26 is fitted, for example, to a machine bed by means of screws 40.

The illustration in FIG. 9 shows a detail of two laminates 18 and 19, with the laminates having a depressed area 13 and a raised area 32. This raised area and depressed area can be produced in particular by means of a stamping process. The laminates 18 and 19 are positioned with respect to one another such that the raised area 33 on one laminate 18 engages in the depressed area 30 in the adjacent laminate 19. This allows the laminates to be positioned better with respect to one another.

The illustration in FIG. 10 shows, schematically, a linear motor 1. The linear motor 1 has a primary part 3 and a secondary part 5. The secondary part 5 has secondary part elements 6 which are arranged in a row.

The illustration in FIG. 11 shows one example of a secondary part element 6 which has permanent magnets. This secondary part element 6 is used to form a secondary part for a linear motor which has a secondary part which can be designed in an unlaminated form, with the primary part together with its windings, which are illustrated schematically in the form of a cross section in FIG. 12, having a laminated core 8 which has windings 52 between teeth 46. This illustrates that a primary part which has a laminated core can also be designed in such a way that the laminates in this laminated core are formed with holding elements. The illustration in FIG. 12 also shows that the laminates 15 in the laminated core can be connected to one another, for example, by means of a weld bead 56.

1-13. (canceled)

14. A laminated core of an electric linear motor, comprising:
a plurality of laminates, and
a connection element in form of a clip having at least one holding element, with the connection element configured to form a friction or interlocking connection between individual laminates which exclusively holds the laminates together.

15. The laminated core of claim 14, wherein the connection element is formed from a single part.

16. The laminated core of claim 14, wherein the connection element is formed from a plurality of parts.

17. The laminated core of claim 14, wherein the connection element has at least two holding elements disposed on an end face of the laminated core.

18. The laminated core of claim 14, wherein the connection element and the laminates have an interlocking connection.

19. The laminated core of claim 18, wherein the interlocking connection is a tongue-and-groove connection.

20. The laminated core of claim 14, wherein at least one of the plurality of laminates is an end laminate, with the end laminates being more rigid than laminates that are different from an end laminate.

21. The laminated core of one of claim 14, wherein the connection element is affixed on a supporting body.

22. The laminated core of claim 14, wherein at least one of the connection element and the holding element has a geometric shape to produce a spring force.

23. The laminated core of claim 14, wherein the laminates have a depressed area and a raised area, with the raised area of one laminate engaging in the depressed area of an adjacent laminate.

24. The laminated core of claim 14, wherein the laminated core forms a secondary part of the linear motor and is exclusive of sources forming a magnetic field.

25. The laminated core of claim 14, wherein the laminated core forms a primary part of the linear motor.

26. A secondary part of an electric linear motor, comprising a laminated core with
a plurality of laminates, and
a connection element in form of a clip having at least one holding element, with the connection element configured to form a friction or interlocking connection between individual laminates which exclusively holds the laminates together.

27. The secondary part of claim 26, wherein the secondary part is a secondary part of an electrical synchronous machine with permanent-magnet excitation.

28. The secondary part of claim 27, wherein the electrical synchronous machine is a linear motor.

29. A primary part of an electric linear motor, comprising a laminated core with
a plurality of laminates, and
a connection element in form of a clip having at least one holding element, with the connection element configured to form a friction or interlocking connection between individual laminates which exclusively holds the laminates together.
